(19) United States
(12) Patent Application Publication
(10) Pub. No.: US 2013/0241491 A1
(43) Pub. Date: Sep. 19, 2013

(54) BALANCED BATTERY PACK SYSTEM BASED ON TWO-WAY ENERGY TRANSFER

(71) Applicants: Jianguo HU, Dongguan City (CN); Shilin Huang, Dongguan City (CN); Yong Cheng, Dongguan City (CN)

(72) Inventors: Jianguo HU, Dongguan City (CN); Shilin Huang, Dongguan City (CN); Yong Cheng, Dongguan City (CN)

(21) Appl. No.: 13/424,293

(22) Filed: Mar. 19, 2012

(51) Int. Cl. H02J 7/00

(52) U.S. Cl. 320/118

(57) ABSTRACT

The invention relates to the technical field of cell balancing system, in particular to a balanced battery pack system based on two-way energy transfer, which comprises battery modules, battery management units, a BMS (Battery Management System) master-control unit and a high-voltage two-way DC/DC circuit module, wherein the battery modules are connected with an internal power bus and an internal CAN (Controller Area Network) bus through the battery management units. The balanced battery pack system based on two-way energy transfer utilizes the high-voltage two-way DC/DC circuit module and the public internal power bus and performs centralized control on the number of balanced channels in the whole battery pack through the BSM master-control unit to realize energy transfer, thus achieving the balancing between various single cells in the whole battery pack and between the battery modules.

### TECHNICAL FIELD OF THE INVENTION

The invention relates to the technical field of cell balancing system, in particular to a balanced battery pack system based on two-way energy transfer.

### BACKGROUND OF THE INVENTION

As the service life of the whole battery pack is severely affected by the unbalance of various single cells in the high-voltage battery pack for a new energy vehicle or an energy storage system, the solution to the unbalance of the single cells has become a key technology in the design of a high-voltage battery pack system. The battery pack consists of a plurality of battery modules, and each battery module consists of a plurality of single cells. In the traditional balancing technology, only the proposal of balancing between various single cells in a single battery pack is provided, which cannot solve the problem of balancing between battery modules, that is to say, the balancing between various single cells in the whole high-voltage battery pack cannot be realized. Moreover, the compensated power balancing is realized by the power supply from vehicle lead-acid batteries, which greatly increases the power consumed by a battery management system from lead-acid batteries without doubt and does not meet the power supply management requirement of vehicle ECUs (Electronic Control Unit) for vehicles.

### SUMMARY OF THE INVENTION

The invention aims to provide a balanced battery pack system based on two-way energy transfer by solving the problems in the prior art. As the balanced battery pack system based on two-way energy transfer utilizes a high-voltage two-way DC/DC circuit module and a public internal power bus and performs the centralized control on the number of balanced channels in the whole battery pack through a BMS master-control unit, the energy transfer between battery modules and the energy transfer between the internal power bus and a high-voltage bus for the battery pack can be realized, thus the balancing between various single cells in the whole battery pack and between the battery modules can be realized. Therefore, the effective recycle of balanced energy is realized and the heat generation problem caused by balancing is avoided.

In order to achieve the aim, the invention provides a balanced battery pack system based on two-way energy transfer, which comprises battery modules and battery management units, wherein the battery modules are connected in series with each other through a high-voltage bus. The balanced battery pack system based on two-way energy transfer also comprises a BMS master-control unit and a high-voltage two-way DC/DC circuit module, wherein a first port of the BMS master-control unit is connected with a first port of the high-voltage two-way DC/DC circuit module through an internal power bus; a second port of the BMS master-control unit is connected with a second port of the high-voltage two-way DC/DC circuit module through an internal CAN bus; a third port of the BMS master-control unit is connected with a third port of the high-voltage two-way DC/DC circuit module through an internal control bus; and the battery modules are connected with the internal power bus and the internal CAN bus through the battery management units.

The BMS master-control unit is provided with a voltage limiting circuit.

The BMS master-control unit is provided with an overvoltage protection circuit.

The BMS master-control unit is provided with a bus voltage real-time monitoring circuit.

The battery management units are provided with voltage sampling circuits.

The battery management units are provided with cell temperature detection circuits.

The battery management units are provided with intra-module cell two-way balancing circuits.

The power bus is a 12V power bus.

The balanced battery pack system based on two-way energy transfer has the advantages that:

1. The effective utilization of energy regeneration is realized through two-way energy transfer, and the heat generation problem caused by balancing is also solved.

2. The balancing between various single cells in the battery pack is realized through two-way energy transfer.

3. The balancing between various battery modules in the battery pack is realized through two-way energy transfer, so that the “staircase” phenomenon of the battery module voltage cannot occur again, thus the service life of the whole battery pack is increased.

4. As the BMS master-control unit is provided with the voltage limiting circuit, the overvoltage problem of the internal power bus is solved and the effective EMC (Electromagnetic Compatibility) control is realized.

### BRIEF DESCRIPTION OF THE DRAWINGS

FIG. 1 is a schematic block diagram of the balanced battery pack system based on two-way energy transfer;

FIG. 2 is a schematic block diagram illustrating the energy transfer between battery modules of the balanced battery pack system based on two-way energy transfer;

FIG. 3 is a schematic block diagram of the balanced battery pack system based on two-way energy transfer, illustrating the energy transfer from a high-voltage bus to an internal power bus; and

FIG. 4 is a schematic block diagram of the balanced battery pack system based on two-way energy transfer, illustrating the energy transfer from the internal power bus to the high-voltage bus.

### DETAILED DESCRIPTION OF THE PREFERRED EMBODIMENTS

Further description is given to the invention with the attached drawings.

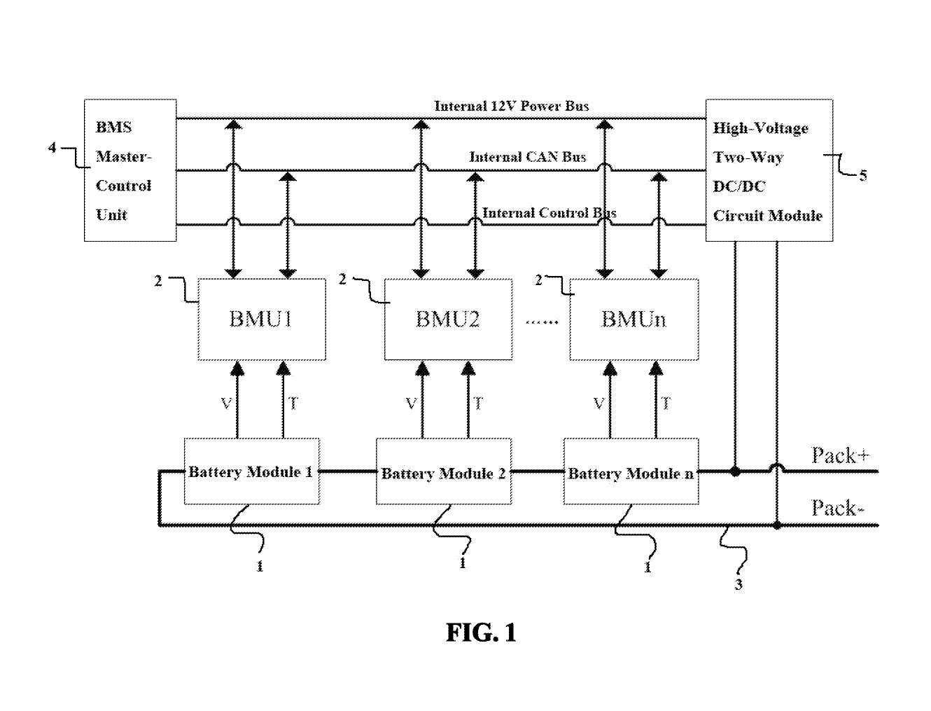

As illustrated in FIG. 1, the balanced battery pack system based on two-way energy transfer provided by the invention comprises battery modules 1 and battery management units 2, wherein the battery modules 1 are connected in series with each other through a high-voltage bus 3. The balanced battery pack system based on two-way energy transfer also comprises a BMS master-control unit 4 and a high-voltage two-way DC/DC circuit module 5, wherein a first port of the BMS master-control unit 4 is connected with a first port of the high-voltage two-way DC/DC circuit module 5 through an internal power bus; a second port of the BMS master-control unit 4 is connected with a second port of the high-voltage two-way DC/DC circuit module 5 through an internal CAN bus; a third port of the BMS master-control unit 4 is connected with a third port of the high-voltage two-way DC/DC circuit module 5 through an internal control bus; and the battery modules 1 are connected with the internal power bus and the internal CAN bus through the battery management units 2.

The BMS master-control unit 4 is provided with a voltage limiting circuit, an overvoltage protection circuit and a bus voltage real-time monitoring circuit, and the battery management units 2 are provided with voltage sampling circuits, cell temperature detection circuits and intra-module cell two-way balancing circuits.

The high-voltage two-way DC/DC circuit module 5 can realize the two-way energy transfer between the high-voltage bus 3 and the internal power bus of the battery pack. Each battery management unit (BMU) 2 realizes the voltage sampling, the cell temperature detection and the intra-module cell two-way balancing of a single cell in a single battery module 1. The BMS master-control unit 4 realizes the overvoltage protection of the internal power bus and the bus voltage real-time monitoring, performs dynamic control on the number of various charge balancing channels and various discharge balancing channels in the battery pack through a unified CAN bus, maintains the dynamic balancing of energy on the internal power bus, and finally realizes the balancing between various single cells in the battery pack. Meanwhile, an interconnected control hard wire is arranged between the BMS master-control unit 4 and the high-voltage two-way DC/DC circuit module 5, so that the current operating state of the high-voltage two-way DC/DC circuit module 5 can be controlled in time when the CAN bus fails, thus the unbalance is avoided.

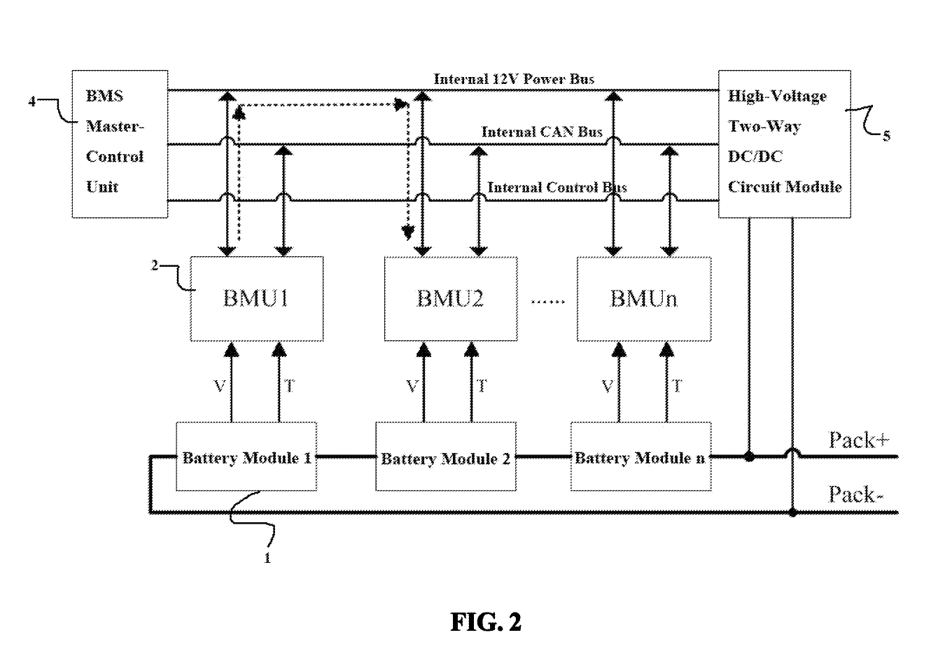

As illustrated in FIG. 2, when the number of single cells requiring charge balancing in the battery pack is equal to that of single cells requiring discharge balancing in the battery pack, the charge balancing and discharge balancing battery management units 2 realize the energy transfer between the battery modules 1 through the interconnected internal power bus.

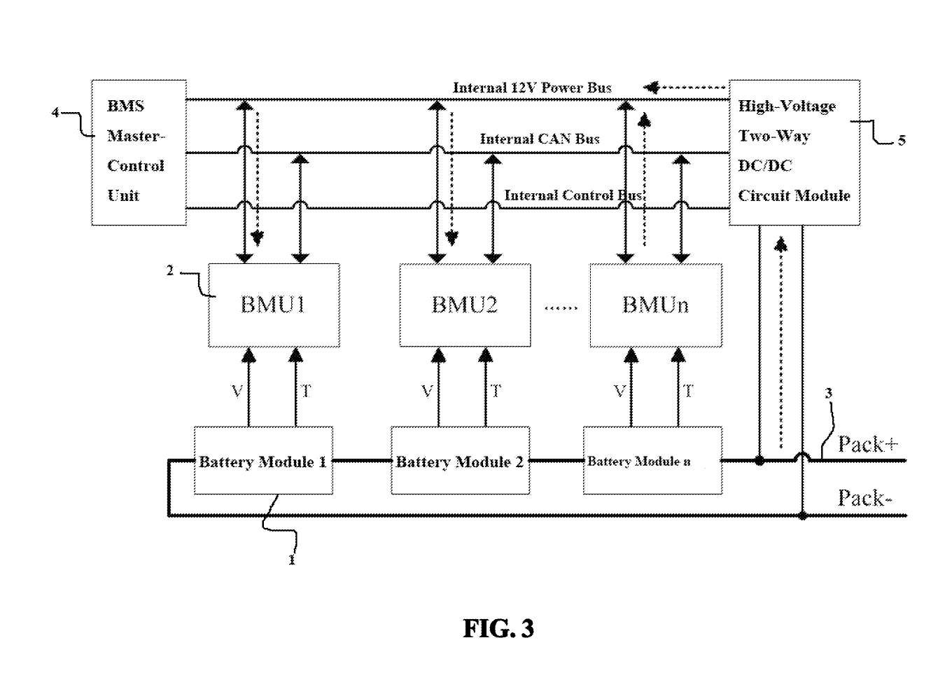

As illustrated in FIG. 3, when the number of the single cells requiring charge balancing in the battery pack is more than that of the single cells requiring discharge balancing in the battery pack, the BMS master-control unit 4 will control the starting of the high-voltage two-way DC/DC circuit module 5, and the energy will be transferred from the high-voltage bus 3 of the battery pack to the internal power bus.

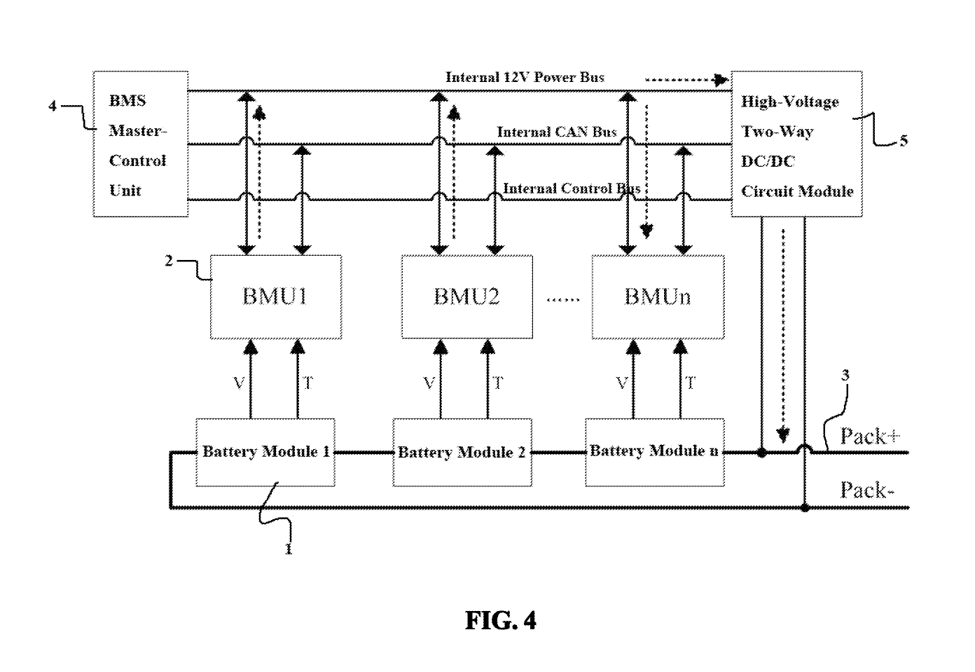

As illustrated in FIG. 4, when the number of the single cells requiring charge balancing in the battery pack is less than that of the single cells requiring discharge balancing in the battery pack, the BMS master-control unit 4 will control the starting of the high-voltage two-way DC/DC circuit module 5, and the energy will be transferred from the internal power bus to the high-voltage bus 3 of the battery pack. The dashed lines and arrowheads in FIGS. 2-4 represent the energy transfer direction.

In summary, as the balanced battery pack system based on two-way energy transfer utilizes the high-voltage two-way DC/DC circuit module 5 and the public internal power bus and performs centralized control on the number of balanced channels in the whole battery pack through the BMS master-control unit 4, the energy transfer between the battery modules 1 and the energy transfer between the internal power bus and the high-voltage bus 3 for the battery pack can be realized, thus the balancing between various single cells in the whole battery pack and between the battery modules 1 can be realized, consequently the effective recycle of balanced energy is realized and the heat generation problem caused by balancing is avoided. Therefore, the balanced battery pack system based on two-way energy transfer can be used together with software to control the two-way transfer of balanced energy, so that the problem of balancing between various single cells in the whole battery pack and between various battery modules 1 can be solved. The balanced battery pack system based on two-way energy transfer can be widely applied to a high-voltage battery pack system, requiring the dynamic balancing of various single cells in a battery pack, in a new energy vehicle or an electric grid energy storage system.

The power bus is a 12V power bus.

Finally, it should be noted that the embodiments are only used to illustrate the technical proposal of the invention and not used to limit the scope of protection of the invention. Although detailed description is given to the invention by reference to the preferred embodiments, it should be understood by those skilled in the art that the modifications on or equivalent replacements to the technical proposal of the invention could be made without deviating from the essence and the scope of the technical proposal of the invention.

What is claimed is:

1. A balanced battery pack system based on two-way energy transfer, comprising battery modules and battery management units, wherein the battery modules connected in series with each other through a high-voltage bus;
the balanced battery pack system based on two-way energy transfer also comprising a BMS master-control unit and a high-voltage two-way DC/DC circuit module, wherein a first port of the BMS master-control unit connected with a first port of the high-voltage two-way DC/DC circuit module through an internal power bus; a second port of the BMS master-control unit connected with a second port of the high-voltage two-way DC/DC circuit module through an internal CAN bus; a third port of the BMS master-control unit connected with a third port of the high-voltage two-way DC/DC circuit module through an internal control bus; and the battery modules connected with the internal power bus and the internal CAN bus through the battery management units.

2. The balanced battery pack system based on two-way energy transfer according to claim 1, wherein the battery management units are provided with voltage sampling circuits.

3. The balanced battery pack system based on two-way energy transfer according to claim 2, wherein the battery management units are provided with cell temperature detection circuits.

4. The balanced battery pack system based on two-way energy transfer according to claim 2, wherein the battery management units are provided with intra-module cell two-way balancing circuits.

5. The balanced battery pack system based on two-way energy transfer according to claim 1, wherein the BMS master-control unit is provided with a voltage limiting circuit.

6. The balanced battery pack system based on two-way energy transfer according to claim 5, wherein the battery management units are provided with voltage sampling circuits.

7. The balanced battery pack system based on two-way energy transfer according to claim 6, wherein the battery management units are provided with cell temperature detection circuits.

8. The balanced battery pack system based on two-way energy transfer according to claim 6, wherein the battery management units are provided with intra-module cell two-way balancing circuits.

9. The balanced battery pack system based on two-way energy transfer according to claim 5, wherein the BMS master-control unit is provided with an overvoltage protection circuit.

10. The balanced battery pack system based on two-way energy transfer according claim 9, wherein the battery management units are provided with voltage sampling circuits.

11. The balanced battery pack system based on two-way energy transfer according to claim 10, wherein the battery management units are provided with cell temperature detection circuits.

12. The balanced battery pack system based on two-way energy transfer according to claim 10, wherein the battery management units are provided with intra-module cell two-way balancing circuits.

13. The balanced battery pack system based on two-way energy transfer according to claim 9, wherein the BMS master-control unit is provided with a bus voltage real-time monitoring circuit.

14. The balanced battery pack system based on two-way energy transfer according to claim 13, wherein the battery management units are provided with voltage sampling circuits.

15. The balanced battery pack system based on two-way energy transfer according to claim 14, wherein the battery management units are provided with cell temperature detection circuits.

16. The balanced battery pack system based on two-way energy transfer according to claim 14, wherein the battery management units are provided with intra-module cell two-way balancing circuits.

17. The balanced battery pack system based on two-way energy transfer according to claim 1, wherein the power bus is a 12V power bus.
